(19) United States
(12) Patent Application Publication
(10) Pub. No.: US 2011/0025274 A1
(43) Pub. Date: Feb. 3, 2011

(54) ENERGY ACCUMULATOR

(76) Inventors: Steffen Kunkel, Hoesbach (DE); Mario Roessler, Bosche (CZ); Markus Backes, Fellbach (DE); Philipp Kohl Rausch, Stuttgart (DE)

Correspondence Address: MICHAEL J. STRIKER, 103 EAST NECK ROAD, HUNTINGTON, NY, 11743, US

(21) Appl. No.: 12/937,288

(22) PCT Filed: Jan. 21, 2009
(86) PCT No.: PCT/EP2009/050634

§ 371 Date: Oct. 11, 2010

(30) Foreign Application Priority Data
Apr. 23, 2008 (DE) 10 2008 001 341.2

(51) Int. Cl. H02J 7/00

(52) U.S. Cl. 320/135

(57) ABSTRACT

The invention relates to an energy storage, containing at least one battery cell, and at least one Zener diode being disposed parallel to the at least one battery cell, wherein the cathode of the Zener diode is connected to the plus terminal of at least one battery cell, and the anode is connected to the minus terminal of at least one battery cell.

The invention relates to an energy accumulator that contains at least one battery cell. In this context, a battery cell is also understood to mean e.g. a rechargeable storage cell or the like. Depending on the desired electrical voltage and the available capacity, energy accumulators of this type can include a plurality of battery cells that are interconnected in series and/or in parallel. The energy accumulator can also include further components that implement auxiliary functions. An auxiliary function of this type can be a capacity display or a current limitation, for example. All components of the energy accumulator can be placed in a housing which can also include connection contacts and/or mechanical fastening devices. Energy accumulators of this type are usually used to supply portable electrical devices e.g. electronic entertainment devices, portable computers, power tools, or garden tools.

The energy accumulator is stored inside or outside of the device during the periods in which an electrical device is not being used. The energy accumulator is stored at a random voltage and with a random stored charge. The charge and the voltage result from the state of charge that existed when usage of the device was halted. It can be a maximum voltage if the energy accumulator was charged using a charging device immediately before it was stored. Furthermore, the storage voltage can be the minimum discharging voltage if a device was operated using the energy accumulator until fully discharged, before being placed in storage. Furthermore, the storage voltage can be between these two extreme values.

From the prior art it is known that battery cells can undergo ageing even when not in use, due solely to storage. Ageing causes the internal resistance of the battery cell to increase, and results in an irreversible loss of capacity. Furthermore, it is known that the ageing of a battery cell that occurs during storage depends on its state of charge. For example, fully charged lithium ion battery cells age more rapidly than battery cells having less charge. Since lithium ion battery cells, in particular, have a very low self-discharge, this results in a fully charged energy accumulator remaining at a high state of charge or a high electrical voltage for a very long time, thereby further accelerating the ageing of these cells.

Proceeding from the prior art, the object of the invention is to provide an energy accumulator that is less susceptible to ageing due solely to storage, without being operated.

The object is solved according to the invention by an energy accumulator that contains at least one battery cell and at least one Zener diode that is situated parallel to at least one battery cell, wherein the cathode of the Zener diode is connected to the positive pole of at least one battery cell, and the anode is connected to the negative pole of at least one battery cell.

According to the invention, it was recognized that the particular battery cells can be discharged, using at least one Zener diode which is connected parallel to at least one battery cell, until these battery cells contain an optimal charge. The optimal charge can be determined such that the user can use the device even after the energy accumulator has been stored for a long period of time, and such that the ageing of the battery cells of the energy accumulator is reduced compared to a higher state of charge. The break-through voltage of the Zener diode is selected such that the discharging current through the Zener diode comes to a halt when a certain specifiable cell voltage of the battery cells has been reached. This cell voltage correlates directly to a stored charge, and so these terms can be used synonymously in the description that follows.

On a case-by-case basis, a plurality of battery cells that are interconnected in series and/or in parallel can be discharged using a single Zener diode. In another embodiment of the invention, one or a plurality of battery cells connected in series and/or in parallel can be discharged using a plurality of series-connected Zener diodes. In this manner, the predetermined storage voltage of the battery cells can be adjusted by selecting the break-through voltage and/or the number of Zener diodes.

Given the discharge of the battery cells of the energy accumulator using at least one Zener diode, which is provided according to the invention, the energy accumulator is discharged to an optimal state of charge within a certain storage period, thereby counteracting the effects of accelerated ageing. At the same time, the circuit does not require a complex regulation algorithm.

To decelerate the discharge of the battery cells, it can be provided that the discharging current be limited using at least one resistor element. The resistor element can be formed, in particular, by a resistor or a transistor. On a case-by-case basis, a person skilled in the art will also consider providing a plurality of components of this type, to control the resistance and, therefore, the current in the discharge line.

In addition, it can be provided that the discharge line and the at least one Zener diode situated therein be separated from the at least one battery cell by a switch element when the energy accumulator is placed in a device. In this manner, the user has access to the full capacity of the battery to operate his mobile electrical device. As soon as the user removes the energy accumulator from the device e.g. to store it, the switch element is closed and the battery cells are discharged using the at least one Zener diode until a predetermined storage voltage is reached. A switching element that is suitable for use in particular is a transistor or a mechanical housing contact that is activated by inserting the energy accumulator into a corresponding housing recess in the electrical device.

The invention is explained below in greater detail with reference to embodiments and figures without limiting the general idea of the invention.

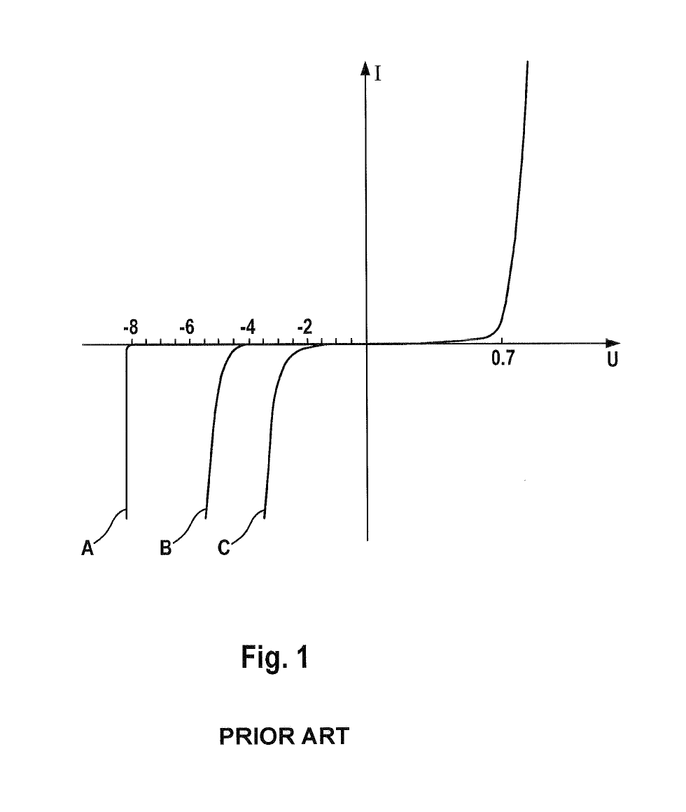

FIG. 1 shows the characteristic curves of three Zener diodes according to the related art.

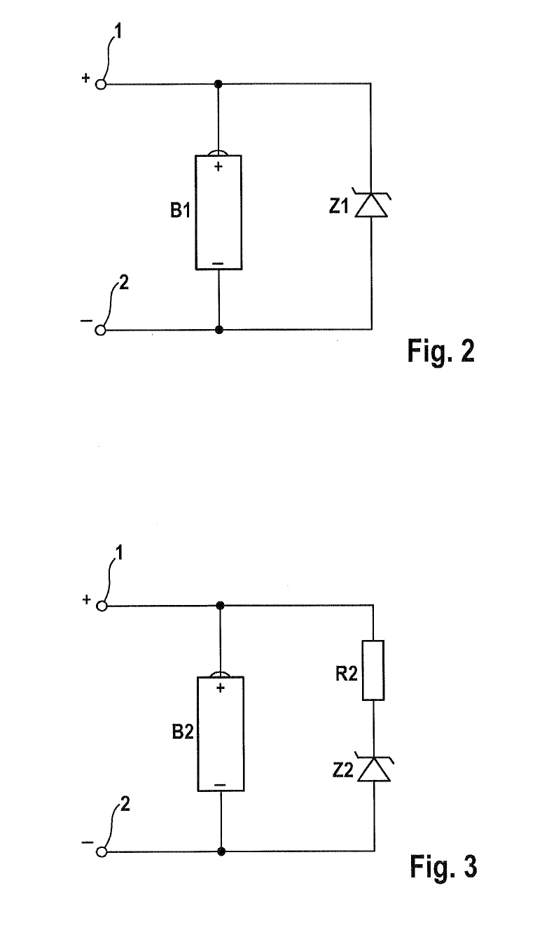

FIG. 2 shows a possible circuit configuration that includes a battery cell and a Zener diode inside an energy accumulator.

FIG. 3 shows a further possible circuit configuration that has an extended discharge time.

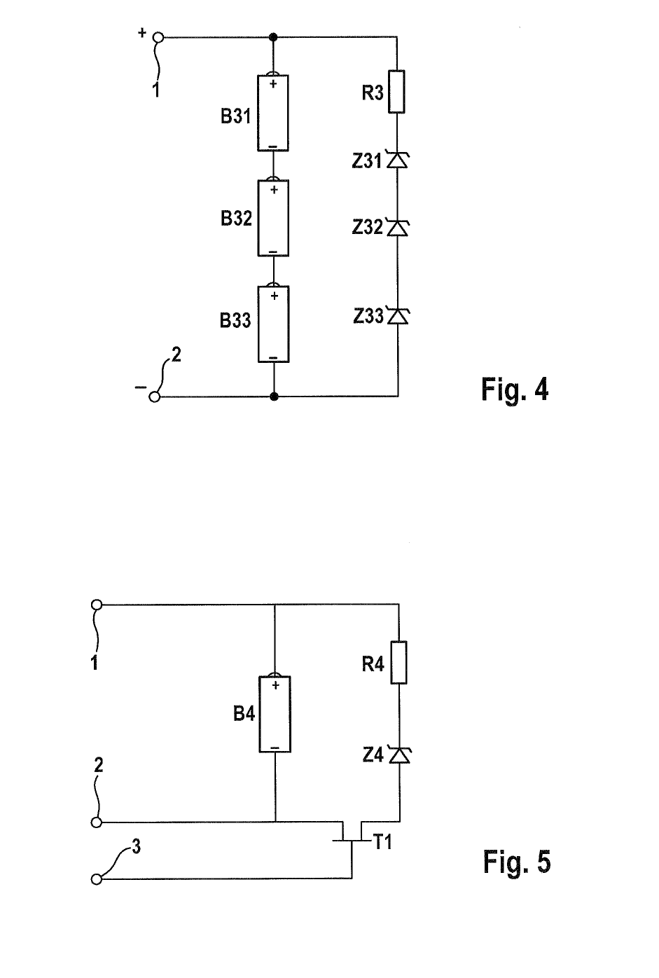

FIG. 4 shows a possible circuit configuration for controlling a plurality of battery cells in one energy accumulator.

FIG. 5 shows a possible circuit configuration, in the case of which the discharging process can be controlled over time.

FIG. 1 shows the characteristic curves of three Zener diodes which were selected as examples. Voltage U at the Zener diode is plotted on the horizontal axis. Current I, which flows through the diode at the particular voltage, is plotted on the vertical axis of the coordinate system.

If the diode is operated in the conducting direction i.e. the cathode is connected to the positive pole of the voltage supply, and the anode is connected to the negative pole, the voltage is depicted in FIG. 1 using a positive sign. In this case, the Zener diode exhibits normal diode behavior i.e. the diode becomes conductive once a threshold voltage of approximately 0.7 V is reached. The current that flows through the diode then increases very rapidly while voltage is applied, provided that the current is not limited by further measures.

According to the invention, the Zener diode is operated in the reverse direction i.e. the cathode is connected to the positive pole of a voltage source, and the anode is connected to the negative pole of a voltage source. This case is depicted as negative voltage in FIG. 1. In this case, the Zener diode blocks the flow of current until a threshold voltage is reached. When the threshold voltage is exceeded, current starts to flow. The current that flows through the Zener diode then increases very rapidly as the voltage increases, provided that the current is not limited by further measures. The threshold voltage at which current starts to flow is also referred to as Zener voltage. Characteristic curve A shown in FIG. 1 represents a diode having a Zener voltage of approximately 8 V. Characteristic curve B represents a diode having a Zener voltage of 5.6 V. Characteristic curve C applies for a diode having a Zener voltage of 2.7 V.

If the level of current that is applied is lower than the Zener voltage, current does not flow through the diode. This does not necessarily mean that the current flow that is measured is exactly 0 amperes. Instead, a slight leakage current can flow through the diode e.g. a tunnel current. A leakage current of this type is preferably less than 25 μA. It can depend on the temperature, ageing, and the voltage that is applied.

FIG. 2 shows an embodiment of a circuit configuration, according to the invention, in an energy accumulator. The energy accumulator includes two connection contacts 1, 2, via which an electrical device is supplied with electrical energy from the energy accumulator. This electrical energy is provided by a battery cell B1. In this context, a battery cell is also understood to mean e.g. a rechargeable storage cell or the like. To increase the capacity, it is also possible to provide a plurality of parallel-connected battery cells which are not depicted in FIG. 2, however. To store the energy accumulator, it should be brought into a state of charge at which the ageing of battery cell B1 is as low as possible. The state of charge of battery cell B1 can be unequivocally identified by a terminal voltage at connection contacts 1, 2. The state of charge or the terminal voltage that should be used for storage can be determined e.g. using computer simulations or by performing experiments using accelerated ageing.

Zener diode Z1 is connected in parallel to battery cell B1, and therefore the cathode of Zener diode Z1 is connected to the positive pole of the battery cell. Furthermore, the anode of the Zener diode is connected to the negative pole of the battery cell. Zener diode Z1 is therefore connected in the reverse direction to battery cell B1 which acts as a voltage source.

The Zener voltage is selected such that the flow of current from battery cell B1 through Zener diode Z1 comes to a halt when the optimal storage current is reached, except for the unavoidable leakage current of Zener diode Z1. In this manner, the optimal storage voltage sets in at battery cell B1 after a specifiable period of time that is defined by the charge content of battery cell B1 and the current flowing through Zener diode Z1.

Zener diode Z1 and the at least one battery cell B1 and connection contacts 1, 2 are situated in a housing that is not depicted in FIG. 2. The housing can have an outer shape that is complementary to the housing region of the electrical device in which the energy accumulator is accommodated. On a case-by-case basis, further components that are not depicted in FIG. 2 can be situated in the housing. These components can be used e.g. to limit the charging current or discharging current of battery cell B1. If a plurality of battery cells is provided, circuits can be provided to compensate for the states of charge. Furthermore, circuitry parts can be provided for displaying the state of charge, thereby ensuring that the user is always informed about the state of charge of his energy accumulator.

FIG. 3 shows a further configuration of the circuit, which is provided according to the invention, for adjusting an optimal storage voltage. An individual battery cell B2 is also shown in FIG. 3, as an example. A person skilled in the art will adapt the number and interconnection of the battery cells to the requirements of the electrical device, of course. For example, a plurality of battery cells can be interconnected in parallel to increase the voltage. To increase the capacity, a plurality of battery cells can be connected in parallel.

As explained above in association with FIG. 2, the embodiment according to FIG. 3 can also include further circuitry parts that are not depicted.

As explained above in association with FIG. 2, the energy accumulator is designed to provide electrical energy from at least one battery cell B2 to connection contacts 1, 2. In the example depicted in FIG. 3, battery cell B2 is discharged to a specifiable state of charge by resistor R2 and Zener diode Z2.

In this case, Zener diode Z2 is used to limit the current flow as soon as the voltage of battery cell B2 falls below the Zener voltage of Zener diode Z2. Resistor R2 is used to limit the current that flows through Zener diode Z2. Resistor R2 can therefore be dimensioned to adjust the time that passes until a fully charged battery cell B2 has reached its optimal state of charge which is provided for storage.

A further embodiment of the invention is depicted schematically in FIG. 4. In the embodiment depicted in FIG. 4, the supply voltage for an electrical device is provided by three battery cells B31, B32, B33. Series-connected components R3, Z31, Z32 and Z33 are provided to discharge the battery cells to the optimal storage voltage. The series connection of elements R3, Z31, Z32 and Z33 is connected parallel to battery cells B31, B32 and B33.

The Zener voltage of Zener diodes Z31, Z32 and Z33 is selected such that it is approximately ⅓ of the target storage voltage of the series connection of battery cells B31, B32 and B33. In the example shown in FIG. 4, the storage voltage of a single battery cell therefore corresponds to the Zener voltage of a single Zener diode. If the number of Zener diodes differs from the number of battery cells, the Zener diodes are selected such that the sum of their Zener voltages corresponds to the target storage voltage of the battery cells.

Resistor R3 is used to limit the discharging current. A person skilled in the art is also familiar, of course, with the use of the channel area of a field-effect transistor or the collector-emitter path of a bipolar transistor as the resistor. Furthermore, the resistor, which is depicted schematically as R3, can also be designed as a resistor network that includes a plurality of resistors.

The time that passes until the optimal storage voltage is reached results from the state of charge of the energy accumulator and the discharging current that flows over R3, Z31, Z32 and Z33. The discharging current can be adjusted by dimensioning resistor R3.

FIG. 5 shows a further discharging circuit of an energy accumulator according to the invention. It contains at least two terminals 1, 2, via which electrical energy from at least one battery cell B4 is supplied to a connected electrical device. A resistor R4 and Zener diode Z4 are provided for discharging energy accumulator B4 to an optimal charging voltage when the electrical device is not being used. They are detachably connected to energy accumulator B4 via a switch element T1. In the embodiment shown in FIG. 5, switch element T1 is a self-conducting field-effect transistor. It connects resistor R4 and Zener diode Z4 to the negative pole of battery cell B4, provided that no voltage is applied to terminal 3 of the energy accumulator. A discharging current now flows, the magnitude of which is limited by the value of resistor R4 and the resistance of the channel area of field-effect transistor T1. Provided that energy accumulator B4 has reached its optimal storage voltage, the Zener voltage of Zener diode Z4 is failed below and current flow is interrupted.

To charge the energy accumulator, a charging device is connected to contacts 1, 2, and 3. It provides a charging current to contacts 1, 2. Furthermore, the charging device delivers a supply voltage to terminal 3, which opens switch element T1 i.e. the connection of Zener diode Z4 to the negative pole of battery cell B4. In this manner, the charging current does not flow through Zener diode Z4 and resistor R4. The power loss that occurs during the charging procedure is therefore reduced.

If the energy accumulator is stored immediately after the charging procedure, switch element T1 is opened. This occurs since a gate voltage is not applied to field-effect transistor T1 via terminal 3. As a result, battery cell B4 discharges once more immediately via resistor R4 and Zener diode Z4 until the optimal storage voltage is reached.

When the energy accumulator is placed in an electrical device, the electrical device applies a gate voltage to field-effect transistor T1 via terminal 3. Field-effect transistor T1 then blocks the current flow over resistor element R4 and Zener diode Z4. As a result, battery cell B4 is not discharged, provided that energy accumulator is connected to an electrical device. As a result, the full capacity of battery cell B4 is available for operating the electrical device.

A person skilled in the art will recognize that the design of switch element T1 to include a self-conducting field-effect transistor is intended merely to represent an example. A person skilled in the art has the option, of course, of using a biopolar transistor instead of a field-effect transistor. Furthermore, mechanical switch elements can be provided that open the connection to Zener diode Z4 and resistor element R4 when the energy accumulator is placed in an electrical device to be supplied and/or in a charging device. Switch element T1 itself can also be used as a resistor element to control the discharging current.

1. An energy accumulator that contains at least one battery cell (B1, B2, B31, B32, B33, B4),
characterized in that
the energy accumulator contains at least one Zener diode (Z1, Z2, Z31, Z32, Z33, Z4) that is situated parallel to the at least one battery cell (B1, B2, B31, B32, B33, B4), wherein the cathode of the Zener diode (Z1, Z2, Z31, Z32, Z33, Z4) is connected to the positive pole of at least one battery cell (B1, B2, B31, B32, B33, B4), and the anode is connected to the negative pole of at least one battery cell (B1, B2, B31, B32, B33, B4).

2. The energy accumulator according to claim 1,
characterized in that
it also contains at least one resistor element (R2, R3, R4) which is series-connected to the at least one Zener diode (Z1, Z2, Z31, Z32, Z33, Z4).

3. The energy accumulator according to claim 1,
characterized in that
it also contains at least one switch element (T1) which can be used to disconnect the connection of the at least one Zener diode (Z1, Z2, Z31, Z32, Z33, Z4) to at least one pole of a battery cell (B1, B2, B31, B32, B33, B4).

4. The energy accumulator according to claim 3,
characterized in that
the switch element (T1) is designed to disconnect the connection of the at least one Zener diode (Z1, Z2, Z31, Z32, Z33, Z4) to at least one pole of a battery cell (B1, B2, B31, B32, B33, B4) when the energy accumulator is placed in an electrical device and/or in a charging device.

5. The energy accumulator according to claim 3,
characterized in that
the switch element (T1) includes a bipolar transistor and/or a field-effect transistor and/or a mechanical switch contact.

6. The energy accumulator according to claim 1,
characterized in that
it contains a plurality of battery cells (B1, B2, B31, B32, B33, B4) which are interconnected in series, wherein the cathode of at least one Zener diode (Z1, Z2, Z31, Z32, Z33, Z4) is connected to the positive pole of a battery cell, and the anode of at least one Zener diode (Z1, Z2, Z31, Z32, Z33, Z4) is connect to the negative pole of a further battery cell.

7. The energy accumulator according to claim 1,
characterized in that
the Zener voltage of the at least one Zener diode (Z1, Z2, Z31, Z32, Z33, Z4) is selected such that electrical current does not flow through the at least one Zener diode (Z1, Z2, Z31, Z32, Z33, Z4) below a specifiable voltage of the at least one battery cell (B1, B2, B31, B32, B33, B4).

8. An electrical device comprising an energy accumulator according to claim 1.
